(19) United States
(12) Patent Application Publication
(10) Pub. No.: US 2017/0336427 A1
(43) Pub. Date: Nov. 23, 2017

(54) ONLINE LIQUID AUTOSAMPLER AND PROCESSING SYSTEM

(71) Applicant: Sentinel Monitoring Systems, Inc., Tucson, AZ (US)

(72) Inventors: Terry D. Long, Tucson, AZ (US); Steven J. Blomquist, Tucson, AZ (US); Richard Vercillo, Tucson, AZ (US); William Puent, Marshfield, WI (US)

(21) Appl. No.: 15/602,082

(22) Filed: May 22, 2017

Related U.S. Application Data
(60) Provisional application No. 62/339,676, filed on May 20, 2016.

(51) Int. Cl. G01N 35/00; G01N 35/10

(52) U.S. Cl. CPC G01N 35/00584; G01N 35/1004; G01N 35/1081

(57) ABSTRACT

An online liquid autosampler may include a pipette, a depyrogenation system, a sample source, and a movement system. The depyrogenation system may be configured to selectively depyrogenate the pipette. The sample source may be configured to provide a liquid to be sampled to the pipette. The movement system may be coupled to one or more of the pipette, the depyrogenation system, or the sample source. The movement system may be configured to: position the pipette within the depyrogenation system for depyrogenation; position a tip of the pipette within the sample source to aspirate a sample of the liquid from the sample source; and position the pipette to dispense an aliquot of the sample of the liquid into an aliquot sample target.

### CROSS-REFERENCE TO RELATED APPLICATION

This application claims the benefit of and priority to U.S. Provisional App. No. 62/339,676, filed May 20, 2016, which is incorporated herein by reference.

### FIELD

Some embodiments described herein generally relate to online liquid autosamplers and processing systems for bacterial endotoxin monitoring.

### BACKGROUND

Unless otherwise indicated herein, the materials described herein are not prior art to the claims in the present application and are not admitted to be prior art by inclusion in this section.

Bacterial endotoxins are fever producing materials that originate from the cell wall of gram negative bacteria and consist of lipopolysaccharide. Bacterial sepsis is a major cause of fatality worldwide. Sepsis is a multi-step process that involves an uncontrolled inflammatory response by the host cells that may result in multi organ failure and death. Both gram-negative and gram-positive bacteria play a major role in causing sepsis. These bacteria produce a range of virulence factors that enable them to escape the immune defenses and disseminate to remote organs, and toxins that interact with host cells via specific receptors on the cell surface and trigger a dysregulated immune response. Endotoxins make up about 75% of the outer membrane of gram-negative bacteria that are capable of causing lethal shock.

Pharmaceutical, biopharmaceutical, and medical device companies expend significant resources to detect, quantify, and eliminate endotoxins from their manufacturing environment and all product. Endotoxins may be detected using a test method known as Limulus Amebocyte Lysate (LAL) assay, which utilizes a reagent derived from amebocyte blood cells of the Atlantic Horseshoe Crab. The blood cells form a gelatinous clot in the presence of bacterial endotoxins and are used in various techniques of LAL testing.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some embodiments described herein generally relate to online liquid autosamplers and processing systems for bacterial endotoxin monitoring.

In an example embodiment, an online liquid autosampler may include a pipette, a depyrogenation system, a sample source, and a movement system. The depyrogenation system may be configured to selectively depyrogenate the pipette. The sample source may be configured to provide a liquid to be sampled to the pipette. The movement system may be coupled to one or more of the pipette, the depyrogenation system, or the sample source. The movement system may be configured to: position the pipette within the depyrogenation system for depyrogenation; position a tip of the pipette within the sample source to aspirate a sample of the liquid from the sample source; and position the pipette to dispense an aliquot of the sample of the liquid into an aliquot sample target.

In another example embodiment, a method to autosample a liquid for endotoxin analysis using an online liquid autosampler that includes a pipette, a depyrogenation system, a sample source, and a movement system is described. The method may include positioning the pipette within the depyrogenation system using the movement system. The method may also include depyrogenating the pipette within the depyrogenation system at least at a threshold temperature for at least a threshold amount of time. The method may also include positioning a tip of the pipette within the sample source using the movement system. The method may also include aspirating a sample of liquid from within the sample source using the pipette. The method may also include positioning the pipette above an aliquot sample target using the movement system. The method may also include dispensing an aliquot of the sample of the liquid into the aliquot sample target.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A and 1B are block diagrams of example online liquid autosamplers;

FIGS. 2A-2B include perspective views of an example online liquid autosampler;

FIG. 2C is a cross-sectional view of a sample well of the online liquid autosampler of FIGS. 2A and 2B;

FIGS. 2D and 2E include cross-sectional views through a portion of the online liquid autosampler of FIGS. 2A and 2B with the sample well in different positions;

FIG. 2F includes a cross-sectional view through a portion of the online liquid autosampler of FIGS. 2A and 2B with a pipette 204 in a third pipette position;

FIGS. 3A-3B include perspective views of another example online liquid autosampler;

FIGS. 4A-4B include perspective views of another example online liquid autosampler;

FIG. 4C includes a perspective view of a depyrogenation system of the online liquid autosampler of FIGS. 4A-4B with a pipette inside;

FIG. 4D includes a cross-sectional perspective view of the depyrogenation system of FIG. 4C with the pipette inside;

FIG. 4E is a perspective view of various components of the online liquid autosampler of FIGS. 4A and 4B;

FIG. 4F is a cross-sectional view of a sample well of the online liquid autosampler of FIGS. 4A and 4B;

FIGS. 4G and 4H include cross-sectional views through a portion of the online liquid autosampler of FIGS. 4A and 4B with the sample well in different positions;

FIG. 5 is a graphic of an example depyrogenation heating cycle implemented in a depyrogenation system of the online liquid autosampler of FIGS. 2A and 2B;

FIG. 6 illustrates a flow diagram of an example method to autosample a liquid for endotoxin analysis using an online liquid autosampler; and

FIG. 7 illustrates a block diagram of an example computing device 700,

all arranged in accordance with at least one embodiment described herein.

### DETAILED DESCRIPTION OF SOME EXAMPLE EMBODIMENTS

Endotoxin testing may be performed in compliance with the following guidelines: ANSI/AAMI ST72:2011; Bacterial Endotoxins-Test methods, routine monitoring, and alternatives to batch testing; USP <85> Bacterial Endotoxins Test Methods.

The Kinetic Chromogenic LAL method of testing is often used to quantify or detect endotoxins on the basis of a measured color producing reaction, proportional to the interaction of LAL and endotoxin. Samples are dispensed into microplates containing the LAL reagent that are read by a spectrophotometer. The spectrophotometer measures the color intensity directly related to endotoxin concentration of the sample.

Kinetic Chromogenic LAL methods have been in use within laboratories for decades. Handheld, portable methods have been introduced within the last decade and have gained acceptance globally for use in screening raw materials, intermediates, and final product.

Industries that are required to routinely monitor endotoxin levels are desirous of automated endotoxin monitoring systems such as described herein that able to be deployed online for automated periodic monitoring. Embodiments described herein may allow for scheduling of sampling events in the future. Some embodiments may execute these sampling events and capture test results for evaluation by personnel. Thus, some embodiments of automated online systems described herein may improve both the quality and economic impact of routine endotoxin monitoring.

Others have attempted but ultimately failed to satisfy the long felt, unmet need for automated online endotoxin monitoring systems. Lonza, Inc. (Basel, Switzerland) introduced their PyroSense® system in approximately 2008 which could be programmed to perform from 1 up to 12 automated assays per day. Lonza's PyroSense® system incorporated highly complex robotics, fluidics, wet reagents, and complex software algorithms to perform each test. Lonza's PyroSense® system is complicated, physically quite large and cumbersome, and quite expensive. The market determined this solution was not economically feasible.

Around 2006, Charles River Laboratories, Inc. (Waltham, Mass.) introduced a portable endotoxin testing system marketed as the Endosafe®-PTS™ (PTS1000). The company expanded the PTS product portfolio to include a multiple sample testing system known as the Endosafe®-MCS™ (multi-cartridge system) to satisfy the demand of its clients who require higher sample throughput. The MCS™ can test five cartridges simultaneously, or any combination from one to five. However, it is designed to operate within a controlled laboratory environment. It is not able to operate within the manufacturing environment nor support automated online operation with dynamic depyrogenation and management of continuously flowing samples.

Some embodiments described herein satisfy the longfelt global unmet need for online endotoxin monitoring solutions within pharmaceutical, biopharmaceutical, medical device, and other highly regulated markets.

Some embodiments disclosed herein include methods and apparatuses for automated sampling and processing of bacterial endotoxin monitoring of very small samples quantities at high accuracy. One of the critical requirements in performing bacterial endotoxin tests is that the sample container be pyrogen free. Depyrogenation typically is accomplished by heating the sample containers to 250° C. or higher for a period of at least 30 minutes. This depyrogenation routine must be completed prior to pipetting each sample within an online automated sampling and processing system. A particular disclosed online depyrogenation method retains the sampling pipette within a heating element enclosure or depyrogenation chamber. The internal temperature of the pipette is elevated to 250° C. or higher for a period of at least 30 minutes. The pipette is then allowed to cool to desired temperature prior to departing the depyrogenation chamber to collect the sample. The depyrogenation system may include the pipette, constructed of a specific material to withstand heating and cooling cycles, an enclosed heating element, insulation system, and controls system to bring the pipette to the required temperature for the required duration. The specific geometric shape of the pipette in combination with the specific alignment of the pipette tip to the sample receipt vessel may facilitate proper aspiration and dispensing of micro-fluidic samples.

Some embodiments of the sample processing system disclosed herein may ensure the sample product is retained within the pipette only during aspiration and delivery. This may prevent upstream tubing from becoming contaminated with sample product and may ensure proper depyrogenation of surfaces in contact with prior samples.

It is not typically desired for product being sampled to be stagnant as this may increase potential for contamination. It may be desired that the micro-sample be extracted from a flowing stream. A particular disclosed sampling well may facilitate the continuous flow of sample through a vessel (e.g., a sample well) which may allow sample accumulation and aspiration while not impeding flow rates. The combination of the pipette material and shape with the specific sampling well may provide accurate collection of micro-sample volumes from a continuously flowing input sample with input flow rates as low as 0.1 microliters per minute and higher.

In at least one embodiment, the combination of the pipette material and shape and the specific alignment of the pipette tip to the sample receipt vessel may provide accurate delivery of precise micro-volumes from 0.5 microliters up to 250 microliters. Accuracy of delivery may be dependent upon drop formation size which may be dependent upon fluid viscosity and surface tension. Some embodiments described herein may utilize the proximity of the delivery target to the pipette tip end to facilitate and/or ensure that the target delivery volume is consistently removed. The proximity between the target and tip may be variable in some embodiments and can be adjusted to compensate for changes in fluid properties as well as target and pipette properties (materials, dimension changes). In other embodiments higher sample volumes may be collected and delivered with precision and accuracy.

Embodiments of the electronic and embedded systems disclosed herein may enable the automated sampling and processing system disclosed to interface automatically with third parties' microfluidics cartridges and testing systems. In an example embodiment the automated sampling and processing system disclosed automatically separates a third party's single cartridge from a nested stack and then loads this cartridge into the third party's reader. The automated sampling and processing system disclosed may interface directly with the third party's reader device to initiate reader protocols at predetermined time intervals and extract digital copies of results from said third party's reader device. Other embodiments allow for interfacing with various microfluidic systems.

Embodiments of the automated sampling and processing system disclosed herein may manage scheduling of future sampling events. In one embodiment the operator simply inputs the day and time of desired sampling events and loads the microfluidics cartridges or other aliquot sample targets into the magazine. Embodiments of the automated sampling and processing systems disclosed herein may confirm availability of microfluidics cartridges required to complete scheduled events and may confirm the microfluidics cartridges are within their expiration dates per specifications provided by microcassette cartridge manufacturer.

Embodiments of the automated sampling and processing system disclosed herein may automatically initiate heating (e.g., depyrogenation) of the pipette and other required preparatory functions at specific timing intervals tied to the scheduled sampling event. At the scheduled event time the automated sampling and processing system may initiate depyrogenation, sample aspiration, loading of the microfluidics cartridge or other aliquot sample target into the reader, and delivery of precise sample volumes to one or more sample receipt vessels. Upon completion of the third party's reader activities, the automated sampling and processing system may automatically remove and discharge the used microfluidics cartridge and may await the next scheduled event. The automated sampling and processing systems described herein may alternatively or additionally be referred to herein as sample processing systems, online liquid autosamplers, autosamplers, or similar terms.

In an example embodiment, an online liquid autosampler may include a pipette, a depyrogenation system, a sample source such as a sample well, and a movement system. The depyrogenation system may be configured to selectively depyrogenate the pipette. The sample source may be configured to provide a liquid to be sampled to the pipette. The movement system may be coupled to one or more of the pipette, the depyrogenation system, or the sample source. The movement system may include a servo motor, a rotary actuator, a single axis actuator, a multi axis actuator, a robotic arm, a conveyor belt, or any other suitable devices or combinations thereof to move one or more elements relative to one or more other elements. For instance, the movement system may be configured to position the pipette within the depyrogenation system for depyrogenation, position a tip of the pipette within the sample source to aspirate a sample of the liquid from the sample source, and/or position the pipette to dispense an aliquot of the sample of the liquid into an aliquot sample target. The movement system may system may accomplish the foregoing in some embodiments by moving one or more of the pipette, the depyrogenation system, the sample source, and/or the aliquot sample target relative to one or more other components.

Alternatively or additionally, the online liquid autosampler may include a UV sanitizer, a rinse system, and/or other elements or feature as described herein.

Some embodiments may include and/or enable automated sampling and processing of bacterial endotoxin monitoring of very small sample quantities at high accuracy. An online depyrogenation method that may be implemented according to some embodiments may retain the pipette within a heating element enclosure of the depyrogenation system. The internal temperature of the pipette may be elevated to 250° C. or higher for a period of at least 30 minutes. The pipette may be constructed of a material to withstand heating and cooling cycles.

An example sample well according to some embodiments described herein may facilitate a continuous flow of the sample through a funnel or other vessel which may allow sample accumulation and aspiration without impeding flow rates. The pipette may provide accurate collection of micro-sample volumes from a continuously flowing input sample through the sample well with input flow rates as low as 0.1 microliters per minute and higher. In at least one embodiment, a combination of the pipette material and a shape of the pipette tip and the alignment of the pipette tip to the sample well may provide accurate delivery of precise micro-volumes from 0.5 microliters up to 250 microliters. Accuracy of delivery may be dependent upon drop formation size which may be dependent upon fluid viscosity and surface tension. Some embodiments described herein may utilize a proximity of the aliquot sample target to the pipette tip to ensure the target delivery volume is consistently removed from the pipette. The proximity (e.g., distance) between the aliquot sample target and the pipette tip may be adjusted to compensate for changes in fluid properties as well as aliquot sample target and pipette properties (materials, dimension changes). In other embodiments, higher sample volumes (e.g., greater than 250 microliters) may be collected and delivered with precision and accuracy.

Some embodiments may include electronic and/or embedded systems that may enable the automated sampling and processing system disclosed to interface automatically with third party test and/or sample systems, such as with third party microfluidics cartridges and testing systems, titer plates, and/or other third party systems. Some embodiments described herein may manage scheduling of future sampling events, may confirm the availability of aliquot sample targets (e.g., microfluidics cartridges) required to complete scheduled events, may confirm the aliquot sample targets are within their expiration dates per specifications provided by a corresponding manufacturer, may initiate various protocols to depyrogenate the pipette and process the sample, may discharge the used aliquot sample target, and may capture a test result from the third party test system.

Some embodiments of the online liquid autosampler and processing system described herein may allow for aliquot volumes from 250 microliters to 5 milliliters or more and may interface with various third party microfluidics systems, lab-on-a-chip systems, or support other filling and dispensing system needs.

Reference will now be made to the drawings to describe various aspects of some example embodiments of the invention. The drawings are diagrammatic and schematic representations of such example embodiments, and are not limiting of the present invention, nor are they necessarily drawn to scale.

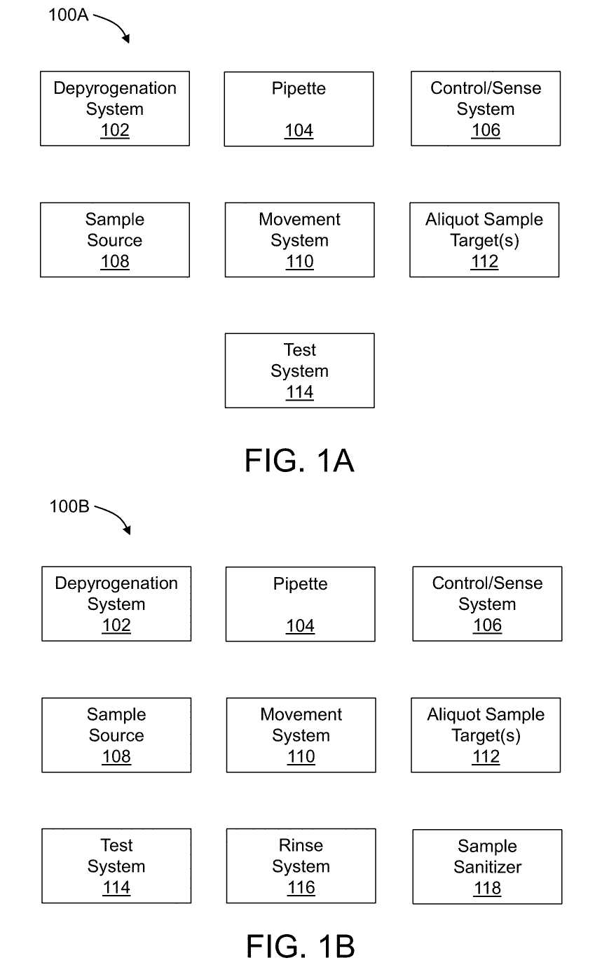

FIGS. 1A and 1B are block diagrams of example online liquid autosamplers hereinafter “autosampler” or “autosamplers”) 100A, 100B, arranged in accordance with at least one embodiment described herein. The autosamplers 100A, 100B may be generically and/or collectively referred to as autosampler 100 or autosamplers 100. Each of the autosamplers 100 may include one or more of a depyrogenation system 102, a pipette 104, a control and/or sense system 106 (hereinafter “control/sense system 106”), a sample source 108, a movement system 110, one or more aliquot sample targets 112, and a test system 114. Alternatively or additionally, as illustrated in FIG. 1B, the autosampler 100B may include one or both of a rinse system 116 and/or a sample sanitizer 118.

The depyrogenation system 102 of FIGS. 1A and 1B may be configured to selectively depyrogenate the pipette 104, and in particular at least a tip of the pipette 104. The depyrogenation system 102 may include one or more of a depyrogenation chamber, a heater block, a gate or door that can be opened to allow entrance and exit of the pipette 104 into the depyrogenation chamber and closed to enclose the pipette 104 in the depyrogenation chamber during depyrogenation, an insulation layer to thermally insulate other components of the autosampler 100A from heat generated by the depyrogenation system 102, a heat exchanger to dissipate excess heat generated by the depyrogenation system 102, a thermocouple or other temperature sensor, and/or other elements or devices.

The pipette 104 of FIGS. 1A and 1B may be configured to aspirate samples of a liquid and to dispense aliquots of the samples of the liquid. The pipette 104 may include quartz glass, soda-lime glass, borosilicate glass, or other material configured to tolerate thermal cycling from depyrogenation. The tip of the pipette 104 may have an internal diameter in a range from 0.1 to 1 millimeter (mm), an external diameter in a range from 0.5 to 5 mm, and a radial thickness in a range from 0.25 to 2.5 mm.

The control/sense system 106 of FIGS. 1A and 1B may include one or more control devices and/or one or more sensors. The one or more control devices may include a controller, a microcontroller, a processor, a microprocessor, a field programmable gate array (FPGA), an application specific integrated circuit (ASIC), or other suitable control device, or any combination thereof. The one or more sensors may include a temperature sensor, an optical sensor, a position sensor, a rotary or linear encoder, a timer, or other suitable sensor, or any combination thereof. In some embodiments, the control/sense system 106 may be configured to control operation of the autosampler 100 based on feedback and/or measurements generated by the control/sense system 106.

As an example, the control/sense system 106 may include a thermocouple or other temperature sensor in the depyrogenation system 102 and a timer. In this and other examples, the control/sense system 106 may be configured to operate the depyrogenation system 102 to heat a heater block of the depyrogenation system to a threshold temperature, such as at least 300° C., and to maintain the heater block at the threshold temperature for a threshold time, such as at least 30 minutes.

As another example, the control/sense system 106 may include one or more linear or rotary encoders or other position sensors configured to sense when the pipette 104 is in predetermined positions to aspirate a sample of the liquid and to dispense aliquots of the sample. In this and other examples, the control/sense system 106 may operate the pipette 104 to aspirate the sample and to dispense the aliquots when in the appropriate positions.

As another example, the control/sense system 106 may include one or more linear or rotary encoders or other position sensors configured to sense when the pipette 104 is in position to be rinsed and/or when the pipette 104 is clear of the sample source 108. In this and other examples, the control/sense system 106 may be configured to operate the rinse system 116 and/or the pipette 104 to rinse the pipette 104 and/or to operate the sample sanitizer 118 to sanitize the sample source 108 to reduce or eliminate formation of bacteria (e.g., bacterial film) on an exposed top surface of the liquid in the sample source 108.

The sample source 108 of FIGS. 1A and 1B may be configured to provide the liquid to be sampled to the pipette 104. The sample source 108 may include one or more microwell tubes or one or more other containers with a non-flowing supply of the liquid, a sample well with a continuous flow of the liquid, or other suitable sample source. In the example of the sample well, the liquid may have a flow rate as low as, e.g., 0.1 microliters per minute and/or in a range from 0.1 microliters per minute to 100 milliliters per minute, such as in a range from 0.1 microliters per minute to 30 milliliters per minute. In another example implementation, the liquid has a flow rate in a range of 0.5-250 microliters per minute, or in a range of 10-15 microliters per minute.

The movement system 110 may be communicatively coupled to the control/sense system 106 and/or may be controlled by the control/sense system 106. The movement system 110 may be coupled to one or more of the depyrogenation system 102, the pipette 104, the control/sense system 106, the sample source 108, the aliquot sample targets 112, the test system 114, the rinse system 116, and/or the sample sanitizer 118. The movement system 110 may be configured to position the pipette 104 within the depyrogenation system 102 for depyrogenation, position the tip of the pipette 104 within the sample source 108 to aspirate a sample of the liquid from the sample source 108, and/or position the pipette 104 to dispense an aliquot of the sample of the liquid into the aliquot sample targets 112. Alternatively or additionally, the movement system 110 may be configured to position the pipette 104 within the rinse system 116 to rinse the pipette 104 and/or to position the sample sanitizer 118 proximate the sample source 108 to sanitize the sample source. The movement system 110 may accomplish the positioning by moving any of the components of the autosampler 100 relative to the other. For instance, the pipette 104 may be positioned within the sample source 108 by moving the pipette 104 relative to the sample source 108, by moving the sample source 108 relative to the pipette 104, and/or by moving each relative to the other in at least one dimension (e.g., by moving the pipette 104 horizontally and by moving the sample source 108 vertically).

The movement system 110 may include one or more of a servo motor, a rotary actuator, a single axis actuator, a multi-axis actuator, or a robotic arm or any combination thereof configured to move one or more of the components of the autosampler 100. In an example implementation, for instance, the movement system 110 includes a single axis actuator mechanically coupled to the pipette 104 and a servo motor mechanically coupled to the sample source 108. The single axis actuator may be configured to selectively move the pipette 104 along a first axis (e.g., horizontally) to at least a first pipette position in which the pipette 104 is positioned within the depyrogenation system 102 and a second pipette position in which the pipette 104 is positioned in alignment with the sample source 108 along the first axis. In an example in which the sample source 108 includes a sample well with a funnel that includes a narrow bottom opening and a top opening, in the second pipette position the pipette 104 may be positioned in alignment with the funnel of the sample well along the first axis with the tip of the pipette 104 aligned along the first axis with the bottom opening of the funnel. The servo motor may be configured to selectively move the sample source 108 along a second axis (e.g., vertically) that is orthogonal to the first axis. In the example in which the sample source 108 includes the sample well, the servo motor may be configured to selectively move the sample well along the second axis when the pipette 104 is in the second pipette position to at least a first sample well position in which the tip of the pipette 104 is within the funnel above the bottom opening of the funnel and a second sample well position in which the tip of the pipette 104 is above the sample well.

The aliquot sample targets 112 may include microcartridges, titer plates, or other aliquot sample targets. As an example, some microcartridges that may be implemented as aliquot sample targets 112 may include four target wells or lanes where two of the four wells/lanes are positive controls and have endotoxin with chromogenic assay. Aliquots of the sample of the liquid may be dispensed into each of the four wells/lanes and then analyzed by the test system 114.

The test system 114 may generally be configured to analyze the aliquot sample targets 112, and more particularly the aliquots of the sample contained therein, for endotoxins. In some embodiments, the test system 114 may include a third party test device and/or system. As an example, the test system 114 may include a portable endotoxin testing system marketed by Charles River Laboratories, Inc. as the Endosafe®-PTS™ test system, or any other suitable test system. A description of the Endosafe®-PTS™ test system is described at http://www.criver.com/files/pdfs/emd/endotoxin/qc_en_d_endosafe_pts_datasheet.aspx (accessed on May 22, 2017), which is incorporated herein by reference in its entirety.

The rinse system 116 may be configured to rinse the pipette 104, including at least the tip of the pipette 104. The rinse system 116 may be configured to rinse the pipette 104 after each aspiration and dispense cycle. Some applications of endotoxin testing may, in the absence of the rinse system 116, result in carbonization of the tip of the pipette 104 due to small residuals of fluid being left at the end of the aspiration and dispense cycle. The residuals may be turned to carbon during the depyrogenation cycle. However, the rinse system 116 may be configured to rinse the pipette 104 after each aspiration and dispense cycle to remove the residuals that may otherwise lead to carbonization. In an example implementation, the rinse system 116 may include a pipette rinse well, a reservoir of cleansing fluid, a pump, and/or other suitable components. Optionally, the pipette rinse well may be coupled to and/or adjacent to the sample source 108 implemented as a sample well.

The sample sanitizer 118 may be configured to sanitize liquid in the sample source 108. The sample source 108 implemented as the sample well described in more detail below may be configured by itself to reduce and/or eliminate formation of bacteria (e.g., bacterial film) in or on the liquid in the sample source 108 in non-sterile environments. The sample sanitizer 118 may be implemented as a backup to further reduce and/or eliminate formation of bacteria (e.g., bacterial film) in or on the liquid in the sample source 108 in non-sterile environments.

The sample sanitizer 118 may include an ultraviolet (UV) sterilizing light emitting diode (LED) or other suitable sanitizer. The sample sanitizer 118 may be configured to be positioned proximate to the sample source 108 to illuminate the liquid in the sample source 108 with UV radiation or otherwise treat the liquid in the sample source 108. For instance, the sample sanitizer 118 may be configured to move between a first sanitizer position in which the sample sanitizer 118 is located over, and more particularly directly above, the sample source 108, and a second sanitizer position in which the sample sanitizer 118 is not located directly above the sample source 108. In some implementations, the sample sanitizer 118 may be moved to the second sanitizer position to allow the pipette 104 to aspirate a sample of the liquid and may be moved to the first sanitizer position between at least some aspirations.

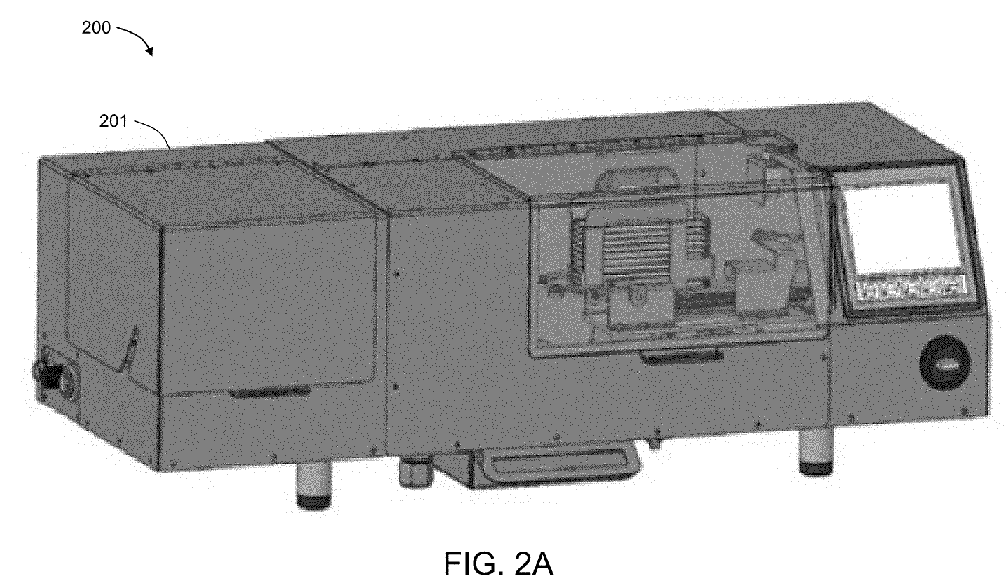

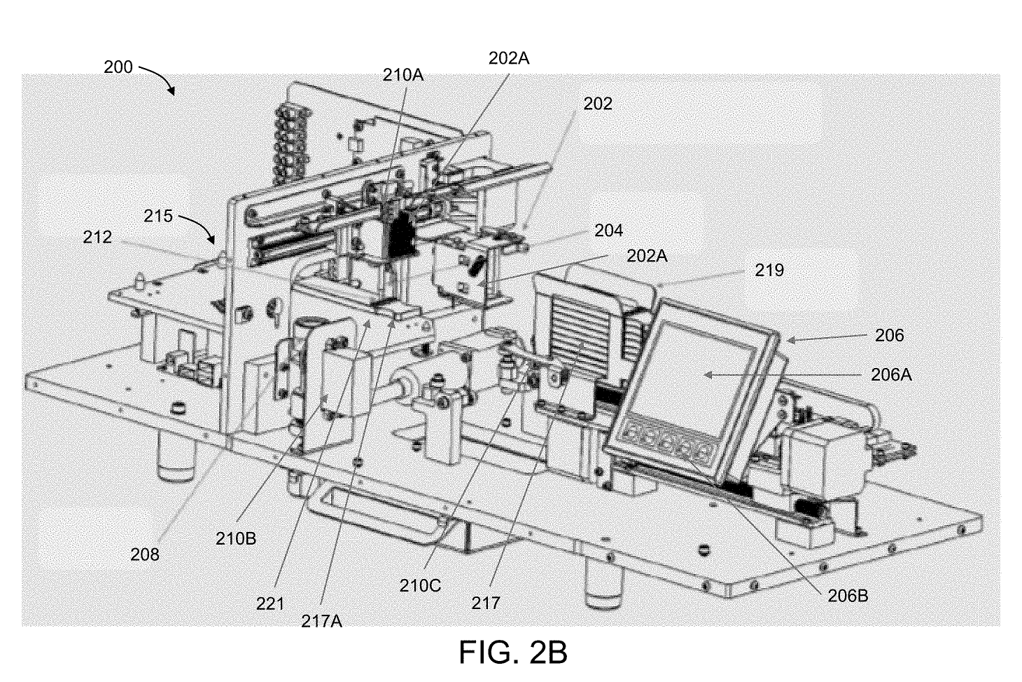

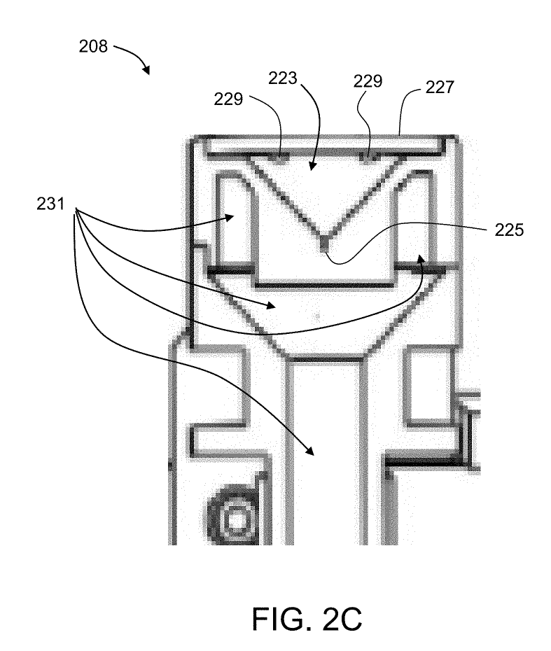

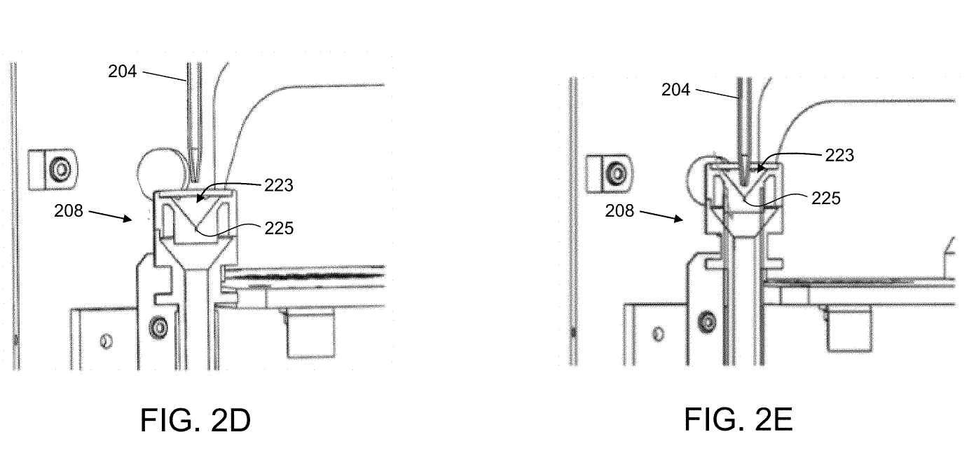

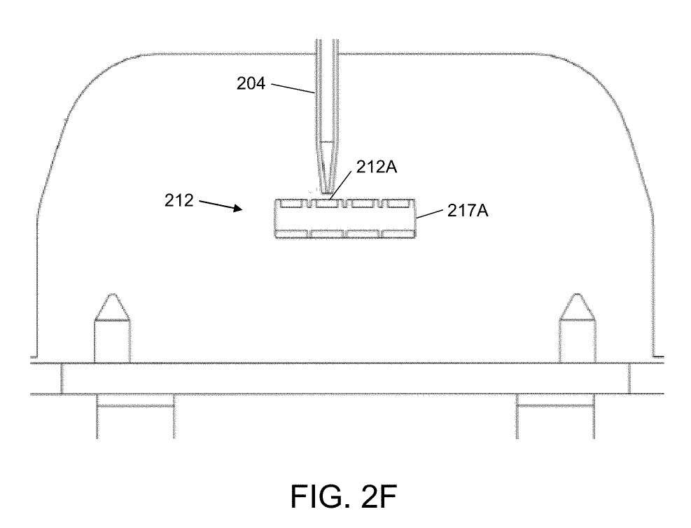

Various example implementations of the autosampler 100 will now be described in turn. FIGS. 2A-2B include perspective views of an example online liquid autosampler (hereinafter “autosampler”) 200, arranged in accordance with at least one embodiment described herein. The autosampler 200 is an example implementation of the autosampler 100A of FIG. 1A. The various components of the autosampler 200 may generally be the same or similar to and/or may include identical components as the other autosamplers discussed herein, except as otherwise noted.

As illustrated in FIG. 2A, the autosampler 200 may include a housing and/or shroud (hereinafter “housing”) 201. The housing 201 may include a single piece or multiple pieces. In FIG. 2B, the housing 201 has been omitted to view other components of the autosampler 200.

As illustrated in FIG. 2B, the autosampler 200 may include a depyrogenation system 202, a pipette 204, a control and/or sense system 206 (hereinafter “control/sense system 206”), a sample well 208, a movement system that includes components 210A, 210B, 210C (collectively hereinafter “movement system 210”), and one or more aliquot sample targets 212. A test system has been omitted from FIG. 2A but may be placed in a test system bed 215 when present. The depyrogenation system 202, the pipette 204, the control/sense system 206, the sample well 208, the movement system 210, and the one or more aliquot sample targets 212 of FIG. 2B my respectively include or correspond to the depyrogenation system 102, the pipette 104, the control/sense system 106, the sample source 108, the movement system 110, and the one or more aliquot sample targets 112 of FIG. 1A.

The depyrogenation system 202 may include a depyrogenation chamber (not visible in FIG. 2B) accessible by a door or gate 202A. The gate 202A may be movable between an open position (not shown) and a closed position to allow the pipette 204 to enter and exit the depyrogenation chamber while being enclosed within the depyrogenation chamber during depyrogenation.

The control/sense system 206 may include some or all or any of the components previously described with respect to the control/sense system 106 of FIGS. 1A and 1B. As illustrated in FIG. 2B, the control/sense system 206 may further include one or more input and/or output devices, including a display 206A and keys 206B or other input and/or output devices. The display 206A and/or keys 206B may be used by an operator to program the autosampler 200 to schedule and/or perform future sampling events or to otherwise operate the autosampler 200.

The movement system 210 may include a single axis actuator 210A to move the pipette 204 along a first axis, e.g., horizontally, a servo motor 210B to move the sample well 208 along a second axis, e.g., vertically, and a microcartridge loader 210C to move microcartridges 217 from a microcartridge magazine 219 to an aliquot dispense position denoted at 221 in FIG. 2B. Alternatively or additionally, the movement system 210 may include a conveyor belt or other components to move each microcartridge 217 from the aliquot dispense position 221 to an aliquot analysis position in which the aliquots of the microcartridge 217 may be analyzed by the test system. One microcartridge 217A of the microcartridges 217 is illustrated at the aliquot dispense position 221 in FIG. 2B. The movement system 210 may include one or more other components in other embodiments. In the example of FIG. 2B, the one or more aliquot sample targets 212 each includes a corresponding one of the microcartridges 217 when loaded at the aliquot dispense position 221, where each microcartridge includes four target lanes or wells.

The single axis actuator 210 may include a heat exchanger 202A coupled thereto. The heat exchanger 202A may be considered part of the depyrogenation system 202. The heat exchanger 202A may be configured to dissipate excess heat generated during the depyrogenation process.

The pipette 204 may be positionable by the movement system 210, and more particularly by the single axis actuator 210A, at various positions along the axis of the single axis actuator 210A. The axis of the single axis actuator 210A may be referred to as a first axis, an x axis, a horizontal axis, horizontal, or variations thereof. The various positions may include a first pipette position in which the pipette 204 is positioned within the depyrogenation system 202 and a second pipette position in which the pipette 204 is positioned in alignment with the sample well 208 along the first axis, e.g., horizontally. In the second pipette position, the tip of the pipette 204 may be aligned horizontally with a bottom opening of a funnel of the sample well 208. Alternatively or additionally, the various positions may include one or more third pipette positions in which the pipette 204 is positioned above, e.g., directly above, one or more target lanes of a corresponding one of the microcartridges 217 when loaded at the aliquot dispense position 221.

The sample well 208 may be positionable by the movement system 210, and more particularly by the servo motor 210B, at various positions along the axis of the servo motor 210B when the pipette 204 is in the second pipette position in alignment with the sample well 208. The axis of the servo motor 210B may be referred to as a second axis, a z axis, a vertical axis, vertical, or variations thereof. The various positions may include a first sample well position in which the tip of the pipette 204 is within the funnel of the sample well 208 above, e.g., directly above, the bottom opening of the funnel and a second sample well position in which the tip of the pipette 204 is above the sample well 208. In the second sample well position, the tip of the pipette 204 may directly above the bottom opening of the funnel of the sample well 208 but at a greater distance than in the first sample well position.

FIG. 2C is a cross-sectional view of the sample well 208 of the autosampler 200 of FIGS. 2A and 2B, arranged in accordance with at least one embodiment described herein. The sample well 208 may be configured to provide a continuous flow of liquid to be sampled.

In the implementation of FIG. 2C, the sample well 208 may include a funnel or funnel-shaped liquid receptacle (hereinafter “funnel”) 223 with a bottom opening 225 and a top opening 227. The bottom opening 225 is smaller than the top opening 227 and the top opening 227 is open to receive the tip of the pipette 204 for aspiration of samples of the liquid. As illustrated, the funnel 223 of the sample well 208 may include one or more output holes 229 formed at a top of the funnel 223 around a perimeter of the funnel 223.

The sample well 208 may additionally include an input (not shown in the view of FIG. 2C) and an output 231. The input may be in fluid communication with the bottom opening 225 of the funnel 223 to supply the liquid through the bottom opening 225 into the funnel 223. The output 231 may be in fluid communication with the one or more output holes 229 of the funnel 223 to carry away excess liquid from the sample well 208.

In operation, liquid to be sampled may be supplied by the input through the bottom opening 225 into the funnel 223. The liquid may generally flow upward and radially outward toward the output holes 229. The liquid may then exit the funnel 223 through the output holes 229 to be carried away by the output 231. Such a flow of the liquid through the sample well 208 may prevent and/or reduce the likelihood of contaminants being aspirated by the pipette 204. In particular, any contaminants (e.g., dust particles, etc.) that may inadvertently fall into or otherwise arrive in the liquid in the sample well 208 may be carried by the generally radially outward flow of liquid to the output holes 229 to exit the sample well 208.

FIGS. 2D and 2E include cross-sectional views through a portion of the autosampler 200 of FIGS. 2A and 2B with the sample well 208 in different positions, arranged in accordance with at least one embodiment described herein. In FIGS. 2D and 2E, the pipette 204 is in the second pipette position in alignment horizontally with the sample well 208 with the tip of the pipette 204 horizontally aligned with the bottom opening 225 of the funnel 223 of the sample well 208. In FIG. 2D, the sample well 208 is in the second sample well position in which the tip of the pipette 204 is above the sample well 208. In FIG. 2E, the sample well 208 is in the first sample well position in which the tip of the pipette 204 is within the funnel 223 above, e.g., directly above, the bottom opening 225 of the funnel 223. In the embodiment of FIGS. 2D and 2E, the sample 208 is configured to move vertically relative to the pipette 204 between the first and second sample well positions to position the tip of the pipette 204 within or above the sample well 208. In other embodiments, the pipette 204 may be configured to move vertically relative to the sample well 208 to position the tip of the pipette 204 within or above the sample well 208.

FIG. 2F includes a cross-sectional view through a portion of the autosampler 200 of FIGS. 2A and 2B with the pipette 204 in one of the one or more third pipette positions, arranged in accordance with at least one embodiment described herein. As described previously, in each of the one or more third pipette positions, the pipette 204 may be positioned above, e.g., directly above (horizontally aligned with), a target lane 212A of the aliquot sample target 212, which in this example includes the microcartridge 217A. The aliquot sample target 212 in FIG. 2F includes three other target lanes (not labeled) and the one or more third pipette positions may include other positions in which the pipette 204 may be positioned above, e.g., directly above, a corresponding one of the target lanes.

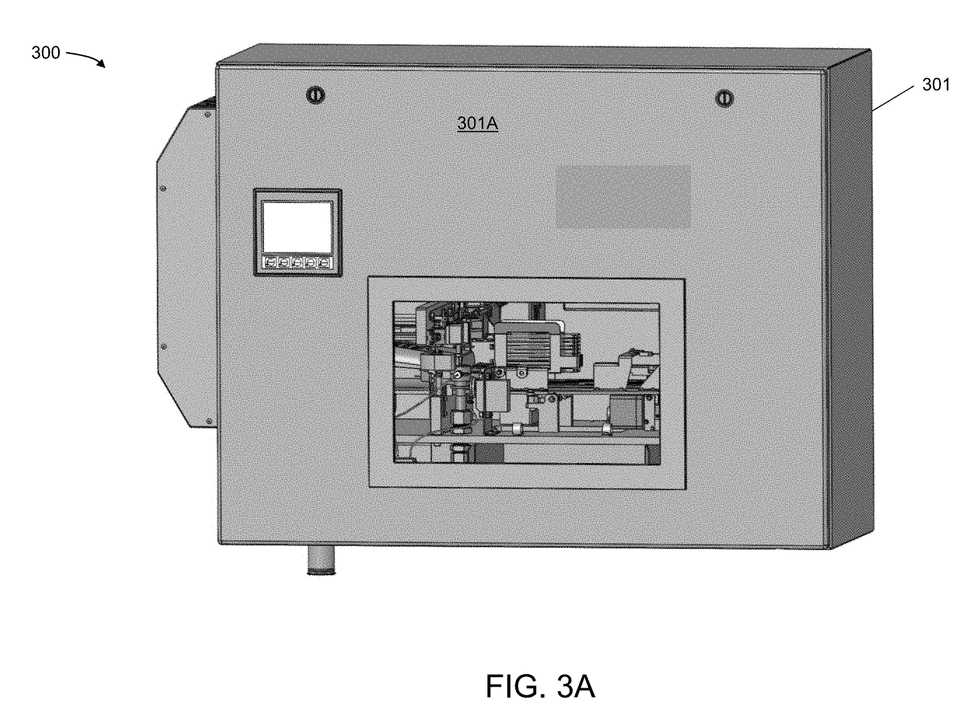

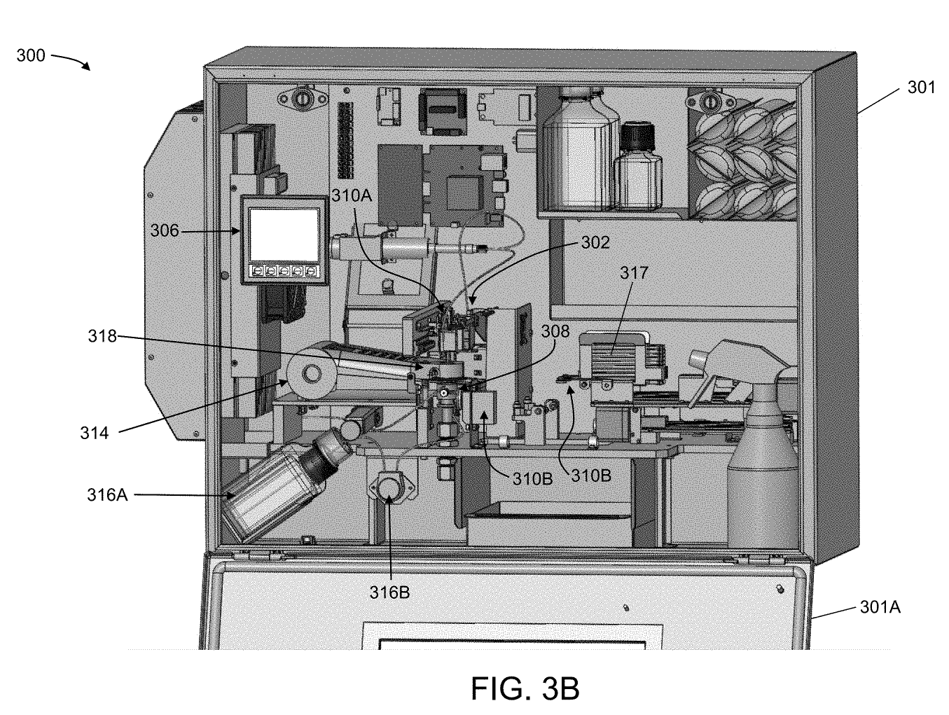

FIGS. 3A-3B include perspective views of another example online liquid autosampler (hereinafter “autosampler”) 300, arranged in accordance with at least one embodiment described herein. The autosampler 300 is an example implementation of the autosampler 100B of FIG. 1B. The various components of the autosampler 300 may generally be the same or similar to and/or may include identical components as the other autosamplers discussed herein, except as otherwise noted.

As illustrated in FIGS. 3A and 3B, the autosampler 300 may include a housing and/or shroud (hereinafter “housing”) 301 with a door 301A. The door 301A is illustrated in a closed position in FIG. 3A and in an open position in FIG. 3B. The housing 301 may include a single piece or multiple pieces.

With reference to FIG. 3B, the autosampler 300 may include a depyrogenation system 302, a pipette (not visible in FIG. 3B), a control and/or sense system 306 (hereinafter “control/sense system 306”), a sample well 308, a movement system that includes components 310A, 310B, 310C (collectively hereinafter “movement system 310”), one or more aliquot sample targets implement as microcartridges 317, a test system 314, a rinse system that includes components 316A, and 316B (collectively hereinafter “rinse system 316”), and a sample sanitizer 318. The depyrogenation system 302, the pipette, the control/sense system 306, the sample well 308, the movement system 310, the one or more aliquot sample targets, the test system 314, the rinse system 316, and the sample sanitizer of FIG. 3B my respectively include or correspond to the depyrogenation system 102, 202, the pipette 104, 204, the control/sense system 106, 206, the sample source 108, 208, the movement system 110, 210, the one or more aliquot sample targets 112, 212, the test system 214, the rinse system 116, and/or the sample sanitizer 118 of FIGS. 1B and/or 2A-2B.

The sample well 308 may include the same or similar funnel configuration with bottom opening in fluid communication with an input and one or more output holes around a perimeter at the top of the funnel in fluid communication with an output, similar to the sample well 208 discussed above. Alternatively or additionally, a pipette rinse well included as part of the rinse system 316 may be coupled and/or adjacent to the sample well 308, an example of which is discussed in more detail elsewhere herein with respect to another example online liquid autosampler (hereinafter “autosampler”) 400.

The movement system 310 may include a single axis actuator 310A, a servo motor 310B, a microcartridge loader 310C, and/or other components which may be the same or similar to components of the movement system 210 discussed elsewhere herein.

The testing system 314 may include a portable endotoxin testing system, such as the portable endotoxin testing system marketed by Charles River Laboratories, Inc. as the Endosafe®-PTS™ test system, or any other suitable test system.

The rinse system 316 may include the pipette rinse well (not visible in FIG. 3B) mentioned in connection with the sample well 308, a reservoir 316A of cleansing fluid, a pump 316B, and/or other suitable components. In some implementations, the pump 316B may be turned on primarily or only during active rinsing of the pipette and may be turned off when not in use to conserve cleansing fluid in the reservoir 316A.

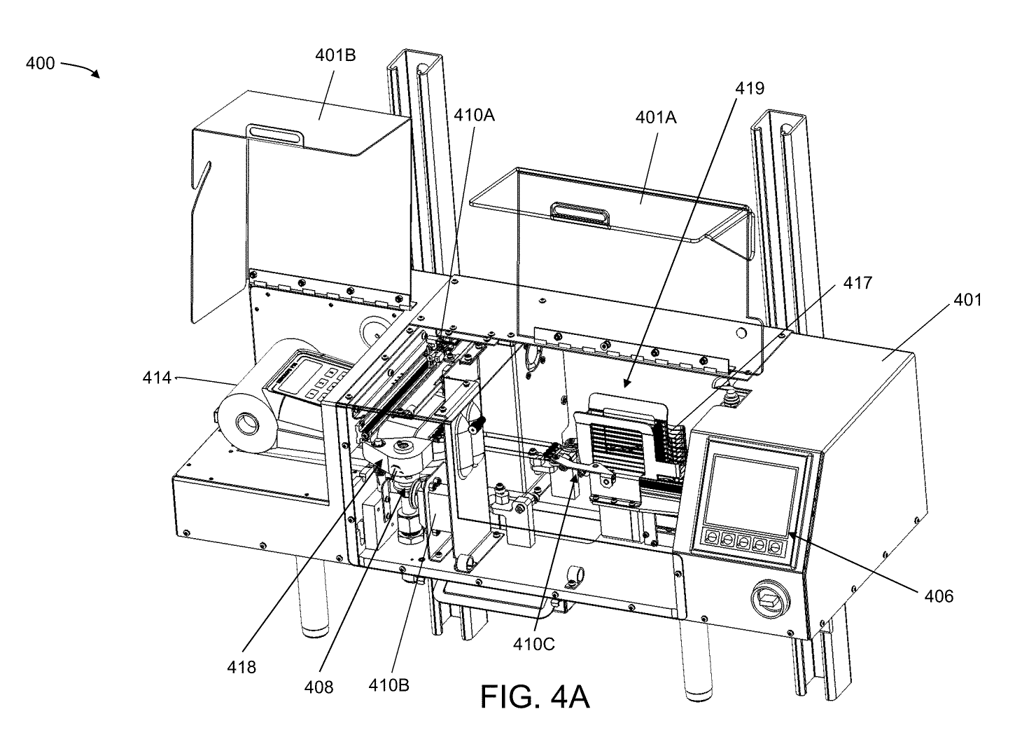

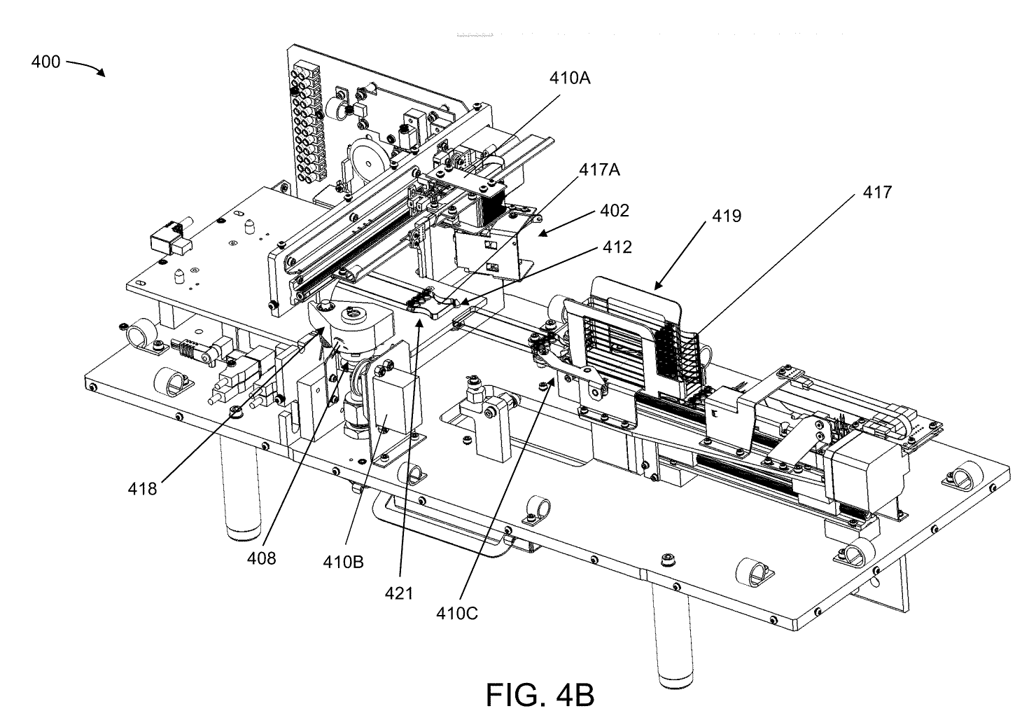

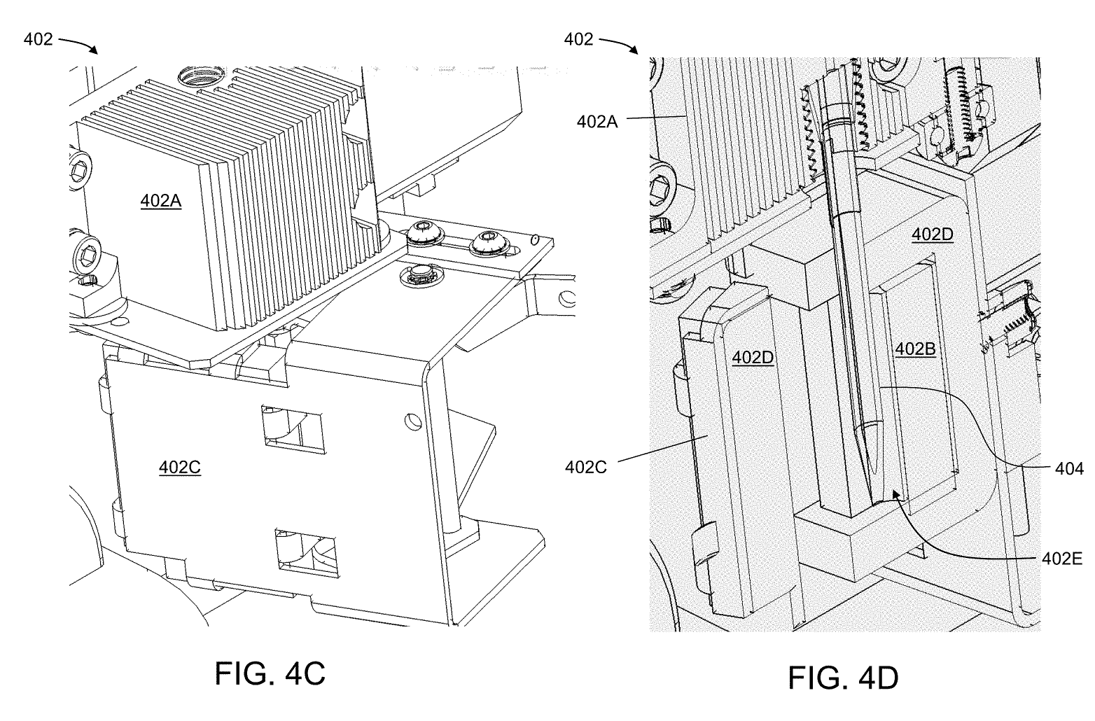

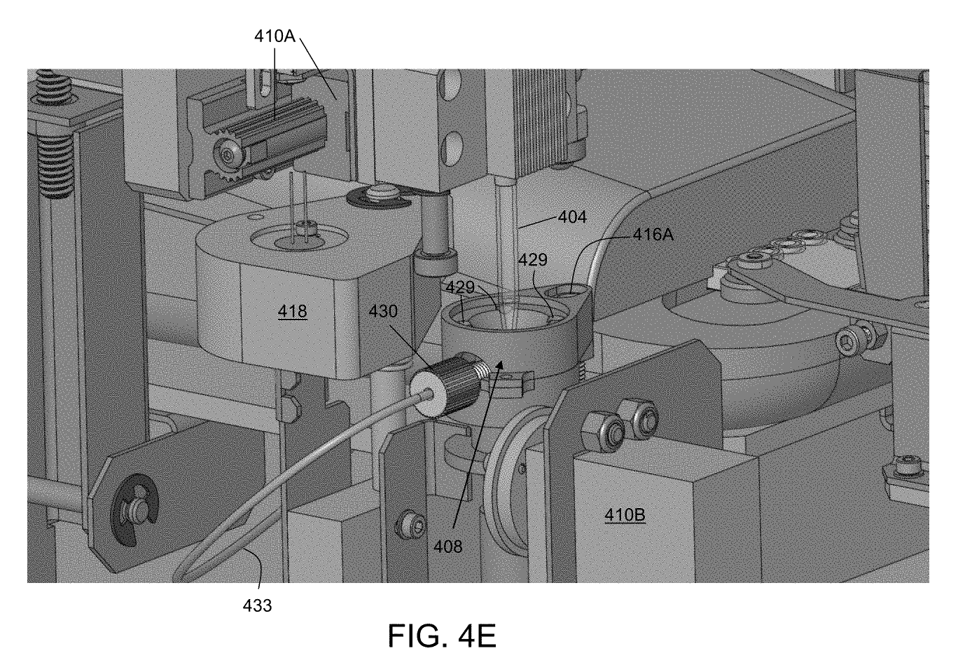

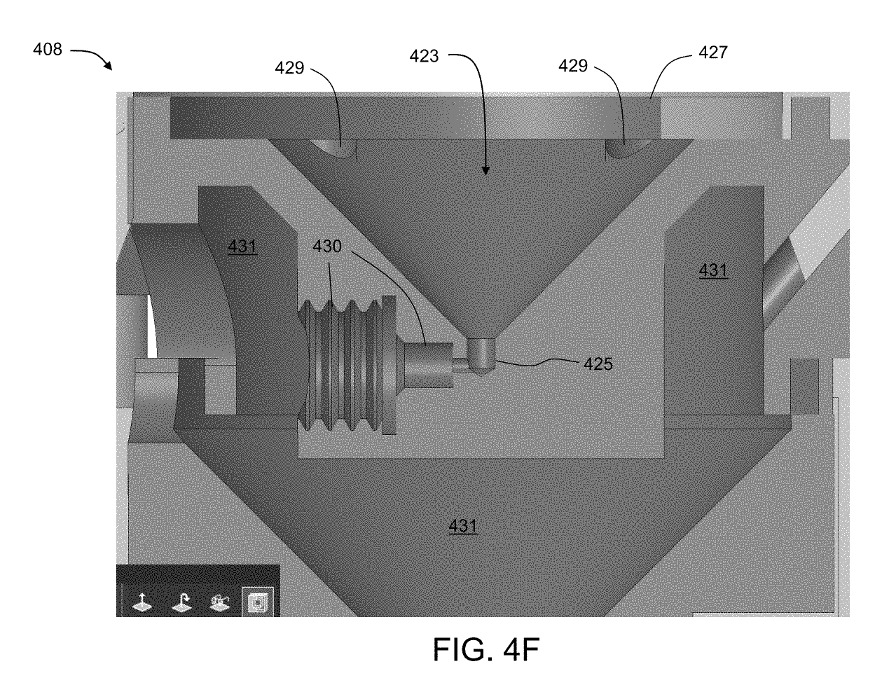

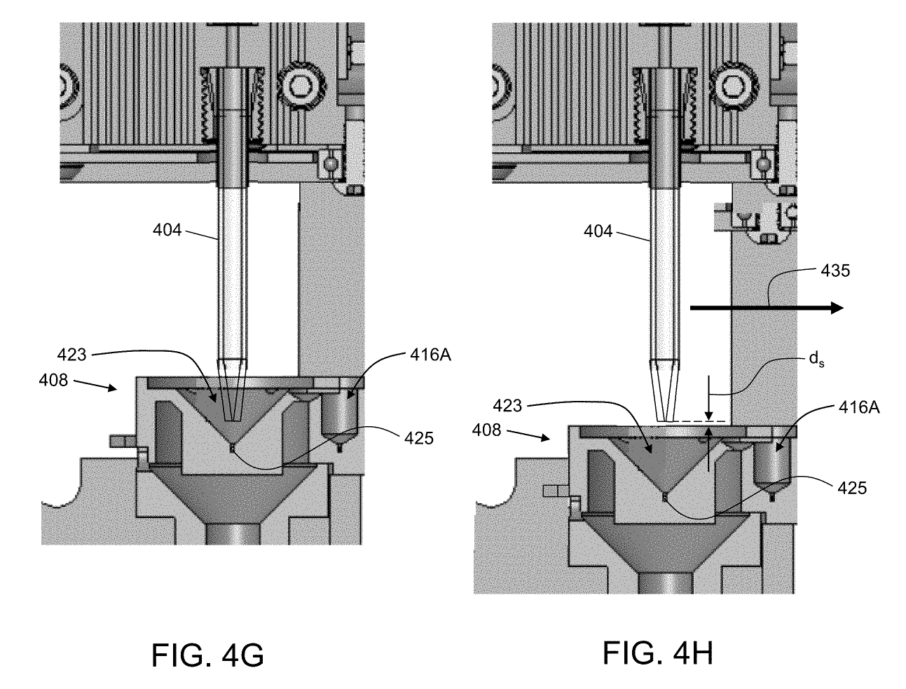

FIGS. 4A-4B include perspective views of another example online liquid autosampler (hereinafter “autosampler”) 400, arranged in accordance with at least one embodiment described herein. The autosampler 400 is another example implementation of the autosampler 100B of FIG. 1B. The various components of the autosampler 400 may generally be the same or similar to and/or may include identical components as the other autosamplers discussed herein, except as otherwise noted.

As illustrated in FIGS. 4A and 4B, the autosampler 400 may include a housing and/or shroud (hereinafter “housing”) 401 with doors 301A, 301B. The doors 301A, 301B are illustrated in open positions in FIG. 4A and the entire housing 401, including the doors 301A, 301B, has been omitted from FIG. 4B. The housing 401 may include a single piece or multiple pieces.

With reference to FIGS. 4A and 4B, the autosampler 400 may include a depyrogenation system 402 (FIG. 4B), a pipette 404 (not visible in FIGS. 4A and 4B), a control and/or sense system 406 (hereinafter “control/sense system 406”, FIG. 4A), a sample well 408, a movement system that includes components 410A, 410B, 410C (collectively hereinafter “movement system 410”), one or more aliquot sample targets 412 implemented as microcartridges 417, a test system 414 (FIG. 4A), a rinse system (not visible in FIGS. 4A and 4B), and a sample sanitizer 418. The depyrogenation system 402, the pipette 404, the control/sense system 406, the sample well 408, the movement system 410, the one or more aliquot sample targets, the test system 414, the rinse system, and the sample sanitizer of FIG. 4B my respectively include or correspond to the depyrogenation system 102, 202, the pipette 104, 204, the control/sense system 106, 206, the sample source 108, 208, the movement system 110, 210, the one or more aliquot sample targets 112, 212, the test system 214, the rinse system 116, and/or the sample sanitizer 118 of FIGS. 1B and/or 2A-2B.

FIG. 4C includes a perspective view of the depyrogenation system 402 with the pipette 404 (not visible in FIG. 4C) inside, arranged in accordance with at least one embodiment described herein. FIG. 4D includes a cross-sectional perspective view of the depyrogenation system 402 with the pipette 404 inside, arranged in accordance with at least one embodiment described herein.

Referring to FIGS. 4C and 4D, the depyrogenation system 402 may include one or more of a heat exchanger 402A, a heater block 402B (FIG. 4D), a gate 402C, and an insulation layer 402D (FIG. 4D).

The heat exchanger 402A may be the same or similar to the heat exchanger 202A discussed elsewhere herein. For instance, the heat exchanger 402A may be coupled to a single axis actuator 410A of the movement system 410.

The heater block 402B may define a depyrogenation chamber 402E configured to accommodate therein the pipette 404, and more particularly, at least the tip of the pipette 404. The heater block 402B may include a copper heater block operated as a resistive heater. In other embodiments, other heaters operating on other principles may be implemented, such as inductive heating, convective heating, or other suitable heating technique.

The gate 402C may be movable between an open position (not shown) and a closed position as illustrated in FIGS. 4C and 4D. The gate 402C may be configured to be placed in the open position to accommodate entry and exit of the pipette 404 from the depyrogenation chamber 404E and may be configured to be placed in the closed position during depyrogenation to confine or at least substantially confine heat generated during depyrogenation to the depyrogenation chamber 402E.

The insulation layer 402D may surround some or all of the heater block 402B and/or may be provided on an inside surface of the gate 402C. In some embodiments, the insulation layer 402D may include aerogel or other suitable insulator. The insulation layer 402D and/or the gate 402C may cooperate with the heater block 402B to enclose or at least substantially enclose the pipette 404, and more particularly at least the tip of the pipette 404, within the depyrogenation chamber 402E during depyrogenation.

Returning to FIGS. 4A and 4B, the movement system 410 may include the single axis actuator 410A to move the pipette 404 along a first axis, e.g., horizontally, a servo motor 410B to move the sample well 408 along a second axis, e.g., vertically, and a microcartridge loader 410C to move the microcartridges 417 from a microcartridge magazine 419 to an aliquot dispense position denoted at 421 in FIG. 4B. One microcartridge 417A of the microcartridges 417 is illustrated at the aliquot dispense position 421 in FIG. 4B. The movement system 410 may include one or more other components in other embodiments. In the example of FIG. 4B, the one or more aliquot sample targets 412 each includes a corresponding one of the microcartridges 417 when loaded at the aliquot dispense position 421, where each microcartridge includes four target lanes or wells.

The pipette 404 may be positionable by the movement system 410, and more particularly by the single axis actuator 410A, at various positions along the axis of the single axis actuator 410A. The axis of the single axis actuator 410A may be referred to as a first axis, an x axis, a horizontal axis, horizontal, or variations thereof. The various positions may include a first pipette position in which the pipette 404 is positioned within the depyrogenation system 402 (e.g., within the depyrogenation chamber 402E of FIG. 4D) and a second pipette position in which the pipette 404 is positioned in alignment with the sample well 408 along the first axis, e.g., horizontally. In the second pipette position, the tip of the pipette 404 may be aligned horizontally with a bottom opening of a funnel of the sample well 408. Alternatively or additionally, the various positions may include one or more third pipette positions in which the pipette 404 is positioned above, e.g., directly above, one or more target lanes of a corresponding one of the microcartridges 417 when loaded at the aliquot dispense position 421.

The sample well 408 may be positionable by the movement system 410, and more particularly by the servo motor 410B, at various positions along the axis of the servo motor 410B when the pipette 404 is in the second pipette position in alignment with the sample well 408. The axis of the servo motor 410B may be referred to as a second axis, a z axis, a vertical axis, vertical, or variations thereof. The various positions may include a first sample well position in which the tip of the pipette 404 is within the funnel of the sample well 408 above, e.g., directly above, the bottom opening of the funnel and a second sample well position in which the tip of the pipette 404 is above the sample well 408. In the second sample well position, the tip of the pipette 404 may directly above the bottom opening of the funnel of the sample well 408 but at a greater distance than in the first sample well position.

FIG. 4E is a perspective view of various components of the autosampler 400 of FIGS. 4A and 4B, arranged in accordance with at least one embodiment described herein. In more detail, FIG. 4E depicts, among others, the single axis actuator 410A with the pipette 404 in the second pipette position, the servo motor 410B with the sample well 408 in the first sample well position, and the sample sanitizer 418 rotated out of the way to allow the tip of the pipette 404 to be positioned within the sample well 408.

FIG. 4E further illustrates a pipette rinse well 416A that may be included in the pipette rinse system of the autosampler 400. The pipette rinse well 416A may be coupled and/or adjacent to the sample well 408 and is discussed in more detail elsewhere herein.

FIG. 4F is a cross-sectional view of the sample well 408 of the autosampler 400 of FIGS. 4A and 4B, arranged in accordance with at least one embodiment described herein. The sample well 408 may be configured to provide a continuous flow of liquid to be sampled.

In the implementation of FIG. 4F, the sample well 408 may include a funnel or funnel-shaped liquid receptacle (hereinafter “funnel”) 423 with a bottom opening 425 and a top opening 427. The bottom opening 425 is smaller than the top opening 427 and the top opening 427 is open to receive the tip of the pipette 404 for aspiration of samples of the liquid. As illustrated, the funnel 423 of the sample well 408 may include one or more output holes 429 formed at a top of the funnel 423 around a perimeter of the funnel 423. The output holes 429 are also denoted in FIG. 4E.

The sample well 408 may additionally include an input 430 and an output 431. The input 430 is also denoted in FIG. 4E. The input 430 may generally include structures formed in the sample well 408 and/or fittings (FIG. 4E) to connect a liquid supply tube 433 (FIG. 4E) to the input 430. The input 430 may be in fluid communication with the bottom opening 425 of the funnel 423 to supply the liquid through the bottom opening 425 into the funnel 423. The output 431 may be in fluid communication with the one or more output holes 429 of the funnel 423 to carry away excess liquid from the sample well 408.

In operation, liquid to be sampled may be supplied from the liquid supply tube 433 to the input 430 and then through the bottom opening 425 into the funnel 423. The liquid may generally flow upward and radially outward toward the output holes 429. The liquid may then exit the funnel 423 through the output holes 429 to be carried away by the output 431. Such a flow of the liquid through the sample well 408 may prevent and/or reduce the likelihood of contaminants being aspirated by the pipette 204. In particular, any contaminants (e.g., dust particles, etc.) that may inadvertently fall into or otherwise arrive in the liquid in the sample well 408 may be carried by the generally upward and radially outward flow of liquid to the output holes 429 to exit the sample well 408.

FIGS. 4G and 4H include cross-sectional views through a portion of the autosampler 400 of FIGS. 4A and 4B with the sample well 408 in different positions, arranged in accordance with at least one embodiment described herein. In FIGS. 4G and 4H, the pipette 404 is in the second pipette position in alignment horizontally with the sample well 408 with the tip of the pipette 404 horizontally aligned with the bottom opening 425 of the funnel 423 of the sample well 408. In FIG. 4G, the sample well 408 is in the first sample well position in which the tip of the pipette 404 is within the funnel 423 above, e.g., directly above, the bottom opening 425 of the funnel 423. In FIG. 4H, the sample well 408 is in the second sample well position in which the tip of the pipette 404 is above the sample well 408. In the embodiment of FIGS. 4G and 4H, the sample 408 is configured to move vertically relative to the pipette 404 between the first and second sample well positions to position the tip of the pipette 404 within or above the sample well 408. In other embodiments, the pipette 404 may be configured to move vertically relative to the sample well 408 to position the tip of the pipette 404 within or above the sample well 408.

In some embodiments, in the second sample well position depicted in FIG. 4H, the tip of the pipette 404 may be vertically separated from an uppermost portion of the sample well 408 (or of the pipette rinse well 416A) by a separation distance dₛ. The separation distance dₛ may be in a range from 0.1 to 2 mm or some other suitable distance. In these and other embodiments, after the pipette 404 aspirates a sample of the liquid, an excess portion of the liquid may initially cling to an exterior of the tip of the pipette 404. This can result in an excessively large first aliquot being dispensed by the pipette 404 if not addressed. The movement system 410 may thus be configured to move the pipette 404 from the second pipette position past the uppermost portion of the sample well 408 along the first axis, e.g., horizontally, as denoted at 435 in FIG. 4H. The uppermost portion of the sample well 408 may be configured to remove the excess portion of the liquid from the exterior of the tip of the pipette 404 as the pipette 404 moves past the uppermost portion of the sample well 408. In particular, because the separation distance dₛ is relatively small, the excess portion of the liquid on the exterior of the tip of the pipette 404 may contact the uppermost portion of the sample well 408 as the pipette 404 moves horizontally past. The excess portion may essentially be grabbed and removed from the tip of the pipette 404 by the uppermost portion of the sample well 408.

The removal of excess liquid as described above may be referred to as a tip wipe protocol. The tip wipe protocol may alternatively or additionally be implemented after rinsing the tip of the pipette 404 in the pipette rinse well 416A. The pipette rinse well 416A may have an output coupled to the output 431 of the sample well 408 and an input coupled to a reservoir of cleansing liquid, such as the reservoir 316A of FIG. 3B. Implementing the tip wipe protocol after rinsing the tip of the pipette 404 in the pipette rinse well 416A may reduce or eliminate the likelihood of the liquid in the sample well 408 being contaminated by cleansing liquid.

The following experimental results are offered by way of illustration of the performance of an actual autosampler implemented as the autosampler 200 discussed in connection with FIGS. 2A-2F.

All bacterial endotoxin experiments were performed with an Endosafe®-PTS™ reader and Endosafe®-PTS™ cartridges (model PTS100, Charles River Laboratories, Inc., Wilmington, Mass., USA) and LAL reagent water (Lonza Biosciences, Walkersville, Md., USA). The Endosafe®-PTS™ reader was mounted onto the autosampler 200 and processing system and electronics interfaces were established. Ten Endosafe®-PTS™ cartridges were loaded into the cartridge magazine. Sampling events were scheduled and executed on the autosampler 200. Test results generated by the Endosafe®-PTS™ reader were captured and are displayed below.

********* ENDOSAFE Test Record *********
V712F Mar. 26, 2015

| | |
|---|---|
| DateTime: | Feb. 17, 2016 @ 16:41:39 |
| Device: | 0491 |
| OperatorID: | 019 |
| Cartridge: | Endotoxin |
| Temperature: | Start: 37.0 C. End: 37.0 C. |
| Method: | KX-122 |
| Cartridge Lot#: | 3308154 |
| Cartridge Cal Code: | 511435062063 |
| Range: | 5-0.05 |
| Range Time: | Sec: 114-750 |
| Onset Times: | >750 292 > 750* 296 |
| Slope: −0.409 | Intercept: +2.343 |
| Dilution: | 1 |
| Sample Lot: | |
| Sample ID: | AS122 |
| Sample Rxn Time CV: | 3.0% |
| Spike Value: | 0.443 EU/mL |
| Spike Rxn Time CV: | 1.0% |
| Spike Recovery: | 111% |
| Test Suitability: | Pass |
| Sample #1 Value: | <0.050 EU/mL |
| Sample #2 Value: | <0.050 EU/mL |
| Sample Value: | <0.050 EU/mL |

For a valid assay the system must use certified, non-expired Endosafe®-PTS™ cartridges as defined by Charles River Laboratories, Inc. and be processed only on Endosafe®-PTS™ readers manufactured by Charles River Laboratories, Inc.

The reproducibility of sample collection and delivery was verified by delivered weight of sample product, examples of which are provided in Table 1 below.

TABLE 1
Micro-volume delivery example
4 each 25 ul deliveries to cartridges loaded on third party's system

| tare wt g | final wt g | mass g | actual vol | steps | steps per ul |
|---|---|---|---|---|---|
| 8.909 | 9.026 | 0.117 | 29.2 | 16000 | 547 |
| 8.913 | 9.041 | 0.128 | 32.0 | 16000 | 500 |
| 8.957 | 9.052 | 0.095 | 23.7 | 13333 | 561 |
| 8.944 | 9.04 | 0.096 | 24.0 | 13333 | 556 |
| 8.934 | 9.034 | 0.1 | 25.0 | 14035 | 561 |
| 8.918 | 9.018 | 0.1 | 25.0 | 14035 | 561 |
| 8.923 | 9.021 | 0.098 | 24.5 | 14035 | 573 |

Accuracy of delivery is dependent upon drop formation size which is dependent upon fluid viscosity and surface tension. The autosampler 200 utilizes the proximity of the delivery target (aliquot sample target 212) to the tip of the pipette 204 to facilitate and/or ensure that the target delivery volume is consistently removed. The proximity between the target and the tip is variable and can be adjusted to compensate for changes in fluid properties as well as target and pipette properties (materials, dimension changes).

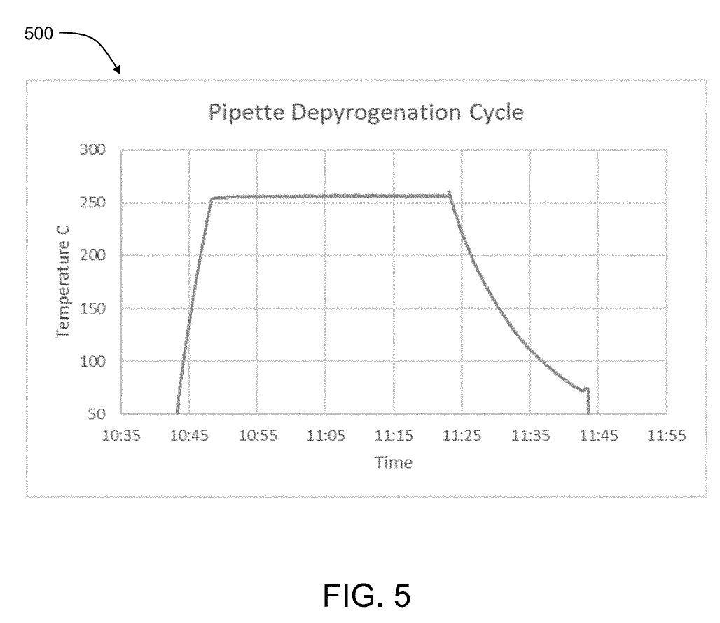

The reproducibility of depyrogenation heating cycles was verified by thermocouple measurements within the pipette 404 while in the depyrogenation chamber. FIG. 5 is a graphic of an example depyrogenation heating cycle 500 implemented in the depyrogenation system 202 of the autosampler 200, arranged in accordance with at least one embodiment described herein. As illustrated in FIG. 5, the depyrogenation cycle 500 generally includes heating the depyrogenation chamber to above 250° C. and maintaining the depyrogenation chamber above 250° C. for at least 30 minutes, followed by natural cooling of the depyrogenation chamber to room temperature. Other depyrogenation cycles may be implemented in other embodiments.

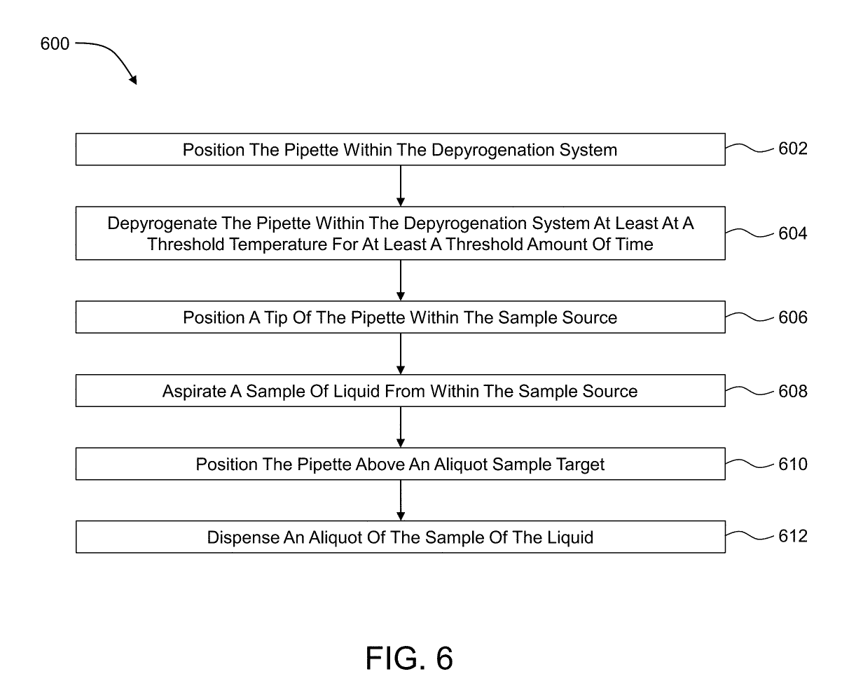

FIG. 6 illustrates a flow diagram of an example method 600 to autosample a liquid for endotoxin analysis using an online liquid autosampler, arranged in accordance with at least one embodiment described herein. The online liquid autosampler may include one or more of the online liquid autosamplers described herein, such as the autosamplers 100, 200, 300, 400 discussed elsewhere herein. In some embodiments, such online liquid autosamplers may include at least a pipette, a depyrogenation system, a sample source, and a movement system such as those described elsewhere herein.

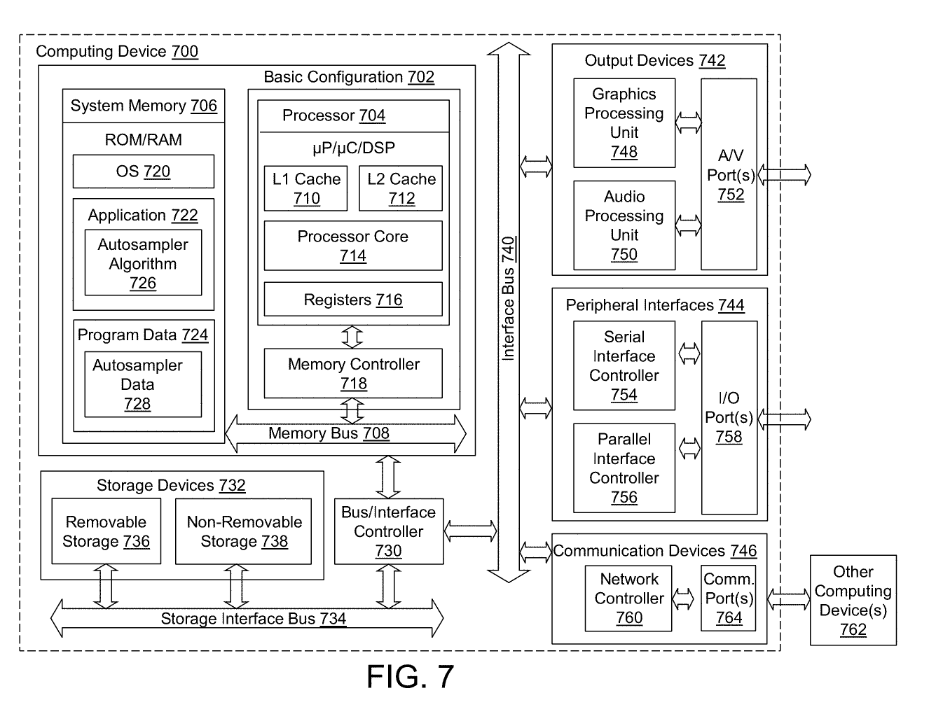

The method 600 may be performed, in whole or in part, by the autosamplers 100, 200, 300, 400 and/or by other autosamplers. Alternatively or additionally, the method 600 may be implemented by a processor device that performs or controls performance of one or more of the operations of the method 600. For instance, a computer (such as the computing device 700 of FIG. 7) or other processor device may be communicatively coupled to the autosampler and/or may be included as a control/sense system of the autosampler and may execute software or other computer-readable instructions accessible to the computer, e.g., stored on a non-transitory computer-readable medium accessible to the computer, to perform or control the autosampler to perform the method 600 of FIG. 6.

The method 600 may include one or more of blocks 602, 604, 606, 608, 610, and/or 612. Although illustrated as discrete blocks, various blocks may be divided into additional blocks, supplemented with additional blocks, combined into fewer blocks, or eliminated, depending on the particular implementation. The method 600 may begin at block 602.

In block 602 (“Position The Pipette Within The Depyrogenation System”), the pipette may be positioned within the depyrogenation system by the movement system. Block 602 may be followed by block 604.

In block 604 (“Depyrogenate The Pipette Within The Depyrogenation System At Least At A Threshold Temperature For At Least A Threshold Amount Of Time”), the pipette may be depyrogenated within the depyrogenation system at least at a threshold temperature for at least a threshold amount of time. The threshold temperature may be 250° C. and the threshold amount of time may be 30 minutes in an example embodiment. Block 604 may be followed by block 606.

In block 606 (“Position A Tip Of The Pipette Within The Sample Source”), a tip of the pipette may be positioned within the sample source using the movement system. Block 606 may be followed by block 608.

In block 608 (“Aspirating A Sample Of Liquid From Within The Sample Source”) a sample of liquid may be aspirated from within the sample source using the pipette. Block 608 may be followed by block 610.

In block 610 (“Positioning The Pipette Above An Aliquot Sample Target Using The Movement System”), the pipette may be positioned above an aliquot sample target using the movement system. Block 610 may be followed by block 612.

In block 612 (“Dispense An Aliquot Of The Sample Of The Liquid”), an aliquot of the sample of the liquid may be dispensed into the aliquot sample target.

One skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

In some embodiments of the method 600 of FIG. 6, the sample source may include a sample well having the configuration illustrated in FIGS. 2C and/or 4F. For instance, the sample well may include a funnel with a bottom opening and a top opening. The bottom opening may be smaller than the top opening and the top opening May be open to receive the tip of the pipette for aspiration of the sample. The funnel may include one or more output holes formed at a top of the funnel around a perimeter of the funnel. The sample well may additionally include an input and an output. The input may be in fluid communication with the bottom opening of the funnel. The output may be in fluid communication with the one or more output holes of the funnel.

In these and other embodiments, the method 600 may further include providing a continuous flow of the liquid through the sample well. Providing a continuous flow of liquid through the sample well may include supplying the continuous flow of liquid from the input through the bottom opening of the funnel into the funnel; flowing the continuous flow of liquid through the funnel from the bottom opening of the funnel toward the top opening of the funnel to the one or more output holes; draining the continuous flow of liquid through the one or more output holes; and carrying away the drained continuous flow of liquid through the output. Alternatively or additionally, in these and other embodiments, positioning the tip of the pipette within the sample source using the movement system may include positioning the tip of the pipette within the funnel aligned with the bottom opening of the funnel and within a range of 10-18 mm above the bottom opening of the funnel.

Alternatively or additionally, the method 600 may further include dispensing the sample of the liquid from the pipette; positioning the tip of the pipette in a rinse well in fluid communication with a reservoir of cleansing liquid; and flowing the cleansing liquid through the rinse well to rinse the tip of the pipette. Alternatively or additionally, the method 600 may include performing the following sequence at least one time to further rinse the tip of the pipette: aspirating a portion of the cleansing liquid into the pipette while the tip of the pipette is positioned in the rinse well with the cleansing liquid flowing through the rinse well; positioning the tip of the pipette above the rinse well; and dispensing the aspirated portion of the cleansing liquid into the rinse well. Optionally, each sequence may include a time delay after dispensing the portion of the cleansing liquid before beginning the next sequence to ensure the cleansing liquid is able to be replenished in the pipette rinse well before the next aspiration of cleansing liquid. Alternatively or additionally, following the last rinse sequence, the tip wipe protocol may be implemented.

Alternatively or additionally, the method 600 may further include, after aspirating the sample of liquid from within the sample source and prior to positioning the pipette above the aliquot sample target, positioning the pipette above the sample source with a vertical distance in a range from 0.1 to 2 mm between an uppermost portion of the sample source and the tip of the pipette, where an excess portion of the liquid initially clings to an exterior of the tip of the pipette. The method 600 may further include moving the pipette past the upper portion of the sample source. The method 600 may further include removing, by the upper portion of the sample source, the excess portion of the liquid from the exterior of the tip of the pipette as the pipette moves past the upper portion of the sample source.

Alternatively or additionally, the method 600 may further include positioning a sample sanitizer over the sample well when the sample well is not in active use and sanitizing the sample well. For instance, a UV LED may be positioned over the sample well and may irradiate the sample well with UV radiation to sanitize the sample well.

FIG. 7 illustrates a block diagram of an example computing device 700, in accordance with at least one embodiment of the present disclosure. The computing device 700 may be used in some embodiments to perform or control performance of one or more of the methods and/or operations described herein. For instance, the computing device 700 may be communicatively coupled to and/or included in the autoamplers 100, 200, 300, 400 described herein to perform or control performance of the method 600 of FIG. 6. In a basic configuration 702, the computing device 700 typically includes one or more processors 704 and a system memory 706. A memory bus 708 may be used for communicating between the processor 704 and the system memory 706.

Depending on the desired configuration, the processor 704 may be of any type including, such as a microprocessor (μP), a microcontroller (μC), a digital signal processor (DSP), or any combination thereof. The processor 704 may include one or more levels of caching, such as a level one cache 710 and a level two cache 712, a processor core 714, and registers 716. The processor core 714 may include an arithmetic logic unit (ALU), a floating point unit (FPU), a digital signal processing core (DSP Core), or any combination thereof. An example memory controller 718 may also be used with the processor 704, or in some implementations the memory controller 718 may be an internal part of the processor 704.

Depending on the desired configuration, the system memory 706 may be of any type, such as volatile memory (such as RAM), non-volatile memory (such as ROM, flash memory, or the like), or any combination thereof. The system memory 706 may include an operating system 720, one or more applications 722, and program data 724. The application 722 may include an autosampler algorithm 726 that is arranged to schedule and/or conduct autosampling operations associated with one or more of the autosamplers described herein. The program data 724 may include autosampler data 728 such as schedule autosampling events, threshold values, and/or other data that may be used to control aspects of the autosampling methods and/or operations described herein. In some embodiments, the application 722 may be arranged to operate with the program data 724 on the operating system 720 to perform one or more of the methods and/or operations described herein, including those described with respect to FIG. 6.

The computing device 700 may include additional features or functionality, and additional interfaces to facilitate communications between the basic configuration 702 and any other devices and interfaces. For example, a bus/interface controller 730 may be used to facilitate communications between the basic configuration 702 and one or more data storage devices 732 via a storage interface bus 734. The data storage devices 732 may include removable storage devices 736, non-removable storage devices 738, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer-readable instructions, data structures, program modules, or other data.

The system memory 706, the removable storage devices 736, and the non-removable storage devices 738 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (e.g., output devices 742, peripheral interfaces 744, and communication devices 746) to the basic configuration 702 via the bus/interface controller 730. The output devices 742 include a graphics processing unit 748 and an audio processing unit 750, which may be configured to communicate to various external devices such as a display or speakers via one or more A/V ports 752. The peripheral interfaces 744 include a serial interface controller 754 or a parallel interface controller 756, which may be configured to communicate with external devices such as input devices (e.g., keyboard, mouse, pen, voice input device, touch input device, and/or others), sensors, or other peripheral devices (e.g., printer, scanner, and/or others) via one or more I/O ports 758. The communication devices 746 include a network controller 760, which may be arranged to facilitate communications with one or more other computing devices 762 over a network communication link via one or more communication ports 764.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that includes one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term “computer-readable media” as used herein may include both storage media and communication media.

The computing device 700 may be implemented as a portion of a small-form factor portable (or mobile) electronic device such as a cell phone, a personal data assistant (PDA), a personal media player device, a wireless web-watch device, a personal headset device, an application-specific device, or a hybrid device that include any of the above functions. The computing device 700 may also be implemented as a personal computer including both laptop computer and non-laptop computer configurations.

The present disclosure is not to be limited in terms of the particular embodiments described herein, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds, compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An online liquid autosampler, comprising:
a pipette;
a depyrogenation system configured to selectively depyrogenate the pipette;
a sample source configured to provide a liquid to be sampled to the pipette;
a movement system coupled to one or more of the pipette, the depyrogenation system, or the sample source and configured to:
position the pipette within the depyrogenation system for depyrogenation;
position a tip of the pipette within the sample source to aspirate a sample of the liquid from the sample source; and
position the pipette to dispense an aliquot of the sample of the liquid into an aliquot sample target.

2. The online liquid autosampler of claim 1, further comprising a pipette rinse well in fluid communication with a reservoir of cleansing liquid and configured to rinse the tip of the pipette after aspiration and dispensation of the sample by the pipette.

3. The online liquid autosampler of claim 1, further comprising an ultraviolet (UV) sample sanitizer positionable over the sample source.

4. The online liquid autosampler of claim 1, wherein the sample source comprises a sample well configured to provide a continuous flow of the liquid, the sample well comprising:
a funnel with a bottom opening and a top opening, wherein the bottom opening is smaller than the top opening and the top opening is open to receive the tip of the pipette for aspiration of the sample, the funnel including one or more output holes formed at a top of the funnel around a perimeter of the funnel;
an input in fluid communication with the bottom opening of the funnel to supply the liquid through the bottom opening into the funnel; and
an output in fluid communication with the one or more output holes of the funnel to carry away excess liquid from the sample well;
wherein the continuous flow of the liquid enters the funnel through the bottom opening and flows up and radially outward to exit the funnel through the one or more output holes.

5. The online liquid autosampler of claim 4, wherein the continuous flow of the liquid has a flow rate in a range from 0.1 microliters per minute to 100 milliliters per minute.

6. The online liquid autosampler of claim 5, wherein the flow rate is in a range from 0.1 microliters per minute to 30 milliliters per minute.

7. The online liquid autosampler of claim 4, wherein the movement system comprises at least one of a servo motor, a rotary actuator, a single axis actuator, a multi-axis actuator, or a robotic arm configured to move one or both of the sample well or the pipette.

8. The online liquid autosampler of claim 7, wherein the movement system comprises:
a single axis actuator mechanically coupled to the pipette and configured to selectively move the pipette along a first axis to at least a first pipette position in which the pipette is positioned within the depyrogenation system and a second pipette position in which the pipette is positioned in alignment with the funnel of the sample well along the first axis with the tip of the pipette aligned along the first axis with the bottom opening of the funnel; and
a servo motor mechanically coupled to the sample well and configured to selectively move the sample well along a second axis that is orthogonal to the first axis when the pipette is in the second pipette position to at least a first sample well position in which the tip of the pipette is within the funnel above the bottom opening of the funnel and a second sample well position in which the tip of the pipette is above the sample well.

9. The online liquid autosampler of claim 8, wherein with the sample well at the second sample well position, the tip of the pipette is in a range from 0.1 to 2 millimeters above an uppermost portion of the sample well in the direction of the second axis.

10. The online liquid autosampler of claim 9, wherein after the pipette aspirates the sample:
an excess portion of the liquid initially clings to an exterior of the tip of the pipette;
the movement system is configured to move the pipette from the second pipette position past the uppermost portion of the sample well along the first axis; and
the uppermost portion of the sample well is configured to remove the excess portion of the liquid from the exterior of the tip of the pipette as the pipette moves past the uppermost portion of the sample well.

11. The online liquid autosampler of claim 1, wherein the pipette comprises quartz glass, soda-lime glass, or borosilicate glass.

12. The online liquid autosampler of claim 11, wherein the tip of the pipette has an internal diameter in a range from 0.1 to 1 millimeter (mm), an external diameter in a range from 0.5 to 5 mm, and a radial thickness in a range from 0.25 to 2.5 mm.

13. The online liquid autosampler of claim 1, further comprising:
a test system configured to analyze one or more aliquots of the sample of the liquid for endotoxins; and
one or more aliquot sample targets, each movable by the movement system to at least an aliquot dispense position to receive an aliquot of the sample of the liquid and to an aliquot analysis position in which the aliquot of the corresponding aliquot sample target is analyzed by the test system.

14. The online liquid autosampler of claim 13, wherein the one or more aliquot sample targets each comprises at least one of:
a microcartridge with one or more aliquot target lanes; or
a titer plate.

15. The online liquid autosampler of claim 1, wherein the depyrogenation system comprises:
a heater block that defines a depyrogenation chamber configured to accommodate therein at least the tip of the pipette;
a gate movable between an open position and a closed position, wherein the gate is configured to be placed in the open position to accommodate entry and exit of the pipette from the depyrogenation chamber and configured to be placed in the closed position during depyrogenation; and
an insulation layer that at least partially surrounds the heater block.

16. The online liquid autosampler of claim 14, wherein the heater block comprises a copper heating block and wherein the insulation layer comprises aerogel insulation.

17. A method to autosample a liquid for endotoxin analysis using an online liquid autosampler that includes a pipette, a depyrogenation system, a sample source, and a movement system, the method comprising:
positioning the pipette within the depyrogenation system using the movement system;
depyrogenating the pipette within the depyrogenation system at least at a threshold temperature for at least a threshold amount of time;
positioning a tip of the pipette within the sample source using the movement system;
aspirating a sample of liquid from within the sample source using the pipette;
positioning the pipette above an aliquot sample target using the movement system; and
dispensing an aliquot of the sample of the liquid into the aliquot sample target.

18. The method of claim 17, wherein:
the sample source comprises a sample well comprising:
a funnel with a bottom opening and a top opening, wherein the bottom opening is smaller than the top opening and the top opening is open to receive the tip of the pipette for aspiration of the sample, the funnel including one or more output holes formed at a top of the funnel around a perimeter of the funnel;
an input in fluid communication with the bottom opening of the funnel; and
an output in fluid communication with the one or more output holes of the funnel;
the method further comprises providing a continuous flow of the liquid through the sample well, including:
supplying the continuous flow of liquid from the input through the bottom opening of the funnel into the funnel;
flowing the continuous flow of liquid through the funnel from the bottom opening of the funnel toward the top opening of the funnel to the one or more output holes;
draining the continuous flow of liquid through the one or more output holes; and
carrying away the drained continuous flow of liquid through the output; and
positioning the tip of the pipette within the sample source using the movement system comprises positioning the tip of the pipette within the funnel aligned with the bottom opening of the funnel and within a range of 10-18 millimeters above the bottom opening of the funnel.

19. The method of claim 17, further comprising:
dispensing the sample of the liquid from the pipette;
positioning the tip of the pipette in a rinse well in fluid communication with a reservoir of cleansing liquid; and
flowing the cleansing liquid through the rinse well to rinse the tip of the pipette.

20. The method of claim 19, further comprising performing the following sequence at least one time to further rinse the tip of the pipette:
aspirating a portion of the cleansing liquid into the pipette while the tip of the pipette is positioned in the rinse well with the cleansing liquid flowing through the rinse well;
positioning the tip of the pipette above the rinse well; and
dispensing the aspirated portion of the cleansing liquid into the rinse well.

21. The method of claim 17, further comprising:
after aspirating the sample of liquid from within the sample source and prior to positioning the pipette above the aliquot sample target, positioning the pipette above the sample source with a vertical distance in a range from 0.1 to 2 millimeters between an uppermost portion of the sample source and the tip of the pipette, wherein an excess portion of the liquid initially clings to an exterior of the tip of the pipette;
moving the pipette past the upper portion of the sample source; and
removing, by the upper portion of the sample source, the excess portion of the liquid from the exterior of the tip of the pipette as the pipette moves past the upper portion of the sample source.
